(19) United States
(12) Patent Application Publication
(10) Pub. No.: US 2026/0178442 A1
(43) Pub. Date: Jun. 25, 2026

(54) DYNAMIC ERROR CONTROL FOR COMPRESSED MEMORY

(71) Applicant: Micron Technology, Inc., Boise, ID (US)

(72) Inventors: Nicola Corna, Gorle (BG) (IT); Nicola Del Gatto, Cassina de' Pecchi (IT)

(21) Appl. No.: 19/418,418

(22) Filed: Dec. 12, 2025

Related U.S. Application Data
(60) Provisional application No. 63/737,325, filed on Dec. 20, 2024.

(51) Int. Cl. G06F 11/10; G06F 12/02

(52) U.S. Cl. CPC G06F 11/1048; G06F 11/1016; G06F 12/0292

(57) ABSTRACT

Methods, systems, and devices for dynamic error control for compressed memory are described. A memory system may include a plurality of memory dies that are each associated with one or more regions for storing compressed data. A compressed region may be configured with a first type of error control capability, such as a single die data correction (SDDC) capability. The memory system may determine an occurrence of an error associated with data stored to a portion (e.g., a sector) of a region configured with the first type of error control capability and may configure the region to operate according to a second type of error control capability, such as a double die data correction (DDDC) capability.

### CROSS REFERENCE

The present Application for Patent claims priority to U.S. Patent Application No. 63/737,325 by Corna et al., entitled “DYNAMIC ERROR CONTROL FOR COMPRESSED MEMORY,” filed Dec. 20, 2024, which is assigned to the assignee hereof, and which is expressly incorporated by reference in its entirety herein.

### TECHNICAL FIELD

The following relates to one or more systems for memory, including dynamic error control for compressed memory.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports dynamic error control for compressed memory in accordance with examples as disclosed herein.

FIG. 2 shows an example of a memory architecture that supports dynamic error control for compressed memory in accordance with examples as disclosed herein.

FIGS. 3A and 3B show examples of memory architectures that support dynamic error control for compressed memory in accordance with examples as disclosed herein.

FIG. 4 shows an example of a sector diagram that supports dynamic error control for compressed memory in accordance with examples as disclosed herein.

FIG. 5 shows an example of a region diagram that supports dynamic error control for compressed memory in accordance with examples as disclosed herein.

FIG. 6 shows an example of a flowchart that supports dynamic error control for compressed memory in accordance with examples as disclosed herein.

FIG. 7 shows a block diagram of a memory system that supports dynamic error control for compressed memory in accordance with examples as disclosed herein.

FIG. 8 shows a block diagram of a memory system that supports dynamic error control for compressed memory in accordance with examples as disclosed herein.

FIGS. 9 and 10 show flowcharts illustrating a method or methods that support dynamic error control for compressed memory in accordance with examples as disclosed herein.

### DETAILED DESCRIPTION

Some memory systems may may include components, such as memory dies or portions of memory dies, that may be manufactured using relatively low quality materials. While the use of relatively lower quality materials may decrease production costs of the memory system, such materials may also result in the associated component(s) being susceptible to a relatively high quantity of errors (e.g., a relatively high failure in time (FIT)). To account for and decrease the occurrence of such errors, some memory systems may utilize a fixed error control scheme, such as single die data correction (SDDC), and may have a relatively high overprovisioning. That is, some memory systems may have a relatively large quantity of memory dies for storing parity information (e.g., parity dies) relative to memory dies for storing data (e.g., data dies). Other memory systems may have relatively lower overprovisioning, but may may increase a minimum access size for data and parity, which may introduce added complexities to the memory system that may otherwise be undesirable. Accordingly, a memory system configured to mitigate errors associated with the use of relatively low quality materials while also having lower overprovisioning without introducing increased access complexities may be desirable.

A memory system configured to mitigate errors associated with the use of relatively low quality materials while also having lower overprovisioning without introducing increased access complexities is described herein. In some examples, such memory systems may utilize multiple (e.g., dynamic) error control schemes. For example, a memory system may include a plurality of memory dies and a plurality of regions that span each of the memory dies. The regions may be associated with storing compressed data (e.g., data encoded, restructured, or otherwise modified to reduce its size) and may be divided into sectors. In some instances, a region may be initially configured to operate according to a first type of error control capability, such as SDDC.

When data stored to a sector of the region experiences an error (e.g., a correctable error), the error control capability of the region may be configured (e.g., reconfigured) to operate according to a second type of error control capability, such as double die data correction (DDDC). By utilizing such a dynamic error control scheme, the memory system may increase the error control capability of a region that may otherwise be susceptible to an uncorrectable error (e.g., a die failure). Thus, the memory system may support relatively low overprovisioning for regions that have not experienced events that may lead to future uncorrectable errors and relatively higher overprovisioning for regions that are more susceptible to uncorrectable errors. Such a scheme may improve the overall performance and reliability of the associated memory system.

In addition to applicability in memory systems as described herein, techniques for dynamic error control for compressed memory may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by increasing the error control capability of regions that may otherwise be susceptible to an uncorrectable error, while allowing for the memory system to have relatively low overprovisioning without adding undesirable complexities associated with increased access sizes, among other benefits.

In addition to applicability in memory systems as described herein, techniques for dynamic error control for compressed memory may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by increasing the error control capability of regions that may otherwise be susceptible to an uncorrectable error, while allowing for the memory system to have relatively low overprovisioning without adding undesirable complexities associated with increased access sizes, among other benefits.

Features of the disclosure are illustrated and described in the context of systems and architectures. Features of the disclosure are further illustrated and described in the context of block diagrams, memory architectures, sector diagrams, region diagrams, and flowcharts.

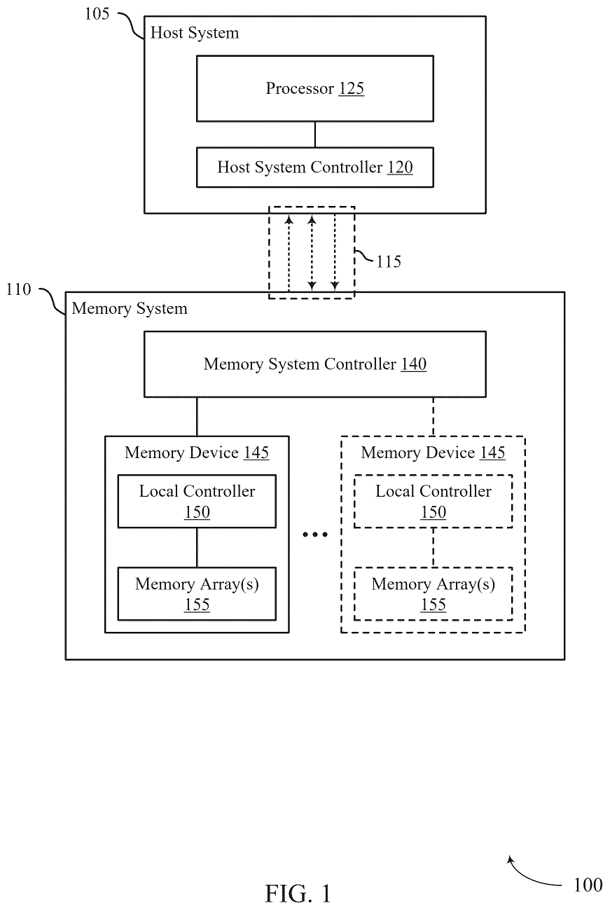

FIG. 1 shows an example of a system 100 that supports dynamic error control for compressed memory in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

The memory system 110 may be configured to mitigate errors associated with the use of relatively low quality materials while also having lower overprovisioning without introducing increased access complexities. In some examples, the memory system 110 may utilize multiple (e.g., dynamic) error control schemes. For example, the memory system 110 may include a plurality of memory dies and a plurality of regions that span each of the memory dies. The regions may be associated with storing compressed data (e.g., data encoded, restructured, or otherwise modified to reduce its size) and may be divided into sectors. In some instances, a region may be initially configured to operate according to a first type of error control capability, such as SDDC.

When data stored to a sector of the region experiences an error (e.g., a correctable error, an error determined or otherwise identified by the memory system controller 140 or an error control engine (not shown)), the error control capability of the region may be configured (e.g., reconfigured) to operate according to a second type of error control capability, such as DDDC. By utilizing such a dynamic error control scheme, the memory system 110 (e.g., the memory system controller 140) may increase the error control capability of a region that may otherwise be susceptible to an uncorrectable error (e.g., a die failure). Thus, the memory system 110 may support relatively low overprovisioning for regions that have not experienced events that may lead to future uncorrectable errors and relatively higher overprovisioning for regions that are more susceptible to uncorrectable errors. Such a scheme may improve the overall performance and reliability of the memory system 110.

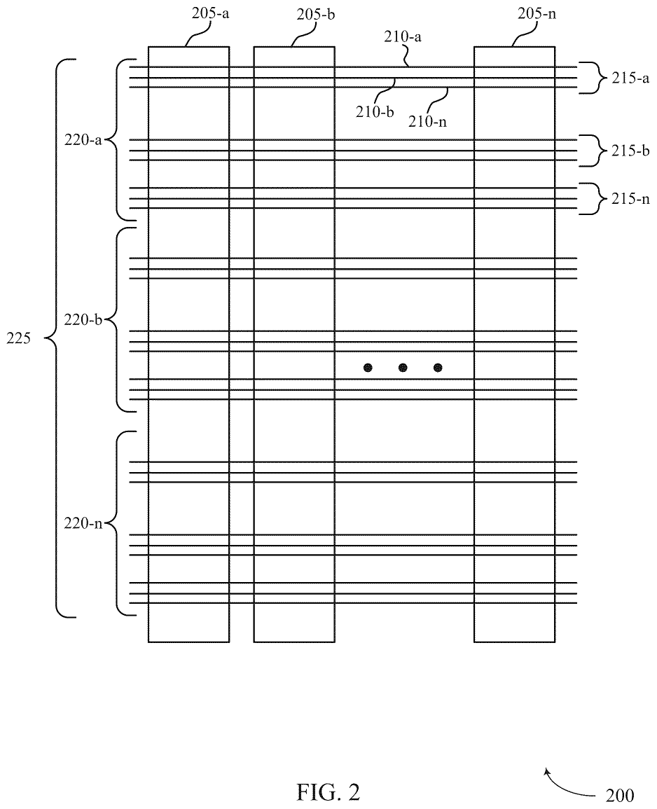

FIG. 2 illustrates an example of a memory architecture 200 that supports dynamic error control for compressed memory in accordance with examples as disclosed herein. The memory architecture 200 may illustrate one or more memory dies 205. In some instances, one or more memory dies may be associated with a codeword 210, one or more codewords 210 may be associated with a management unit (MU) 215, one or more MUs 215 may be associated with a sector 220, and one or more sectors 220 may be associated with a region 225. The memory architecture 200 may utilize different error control schemes for different regions 225, which may support a tradeoff between overprovisioning and reliability for regions 225 that store compressed data, which may improve the overall performance and reliability of the associated memory system.

In some instances, an associated memory system may include a plurality of memory dies 205. For example, the memory system 110 as descried with reference to FIG. 1 may include a memory die 205-a, a memory die 205-b, and a memory die 205-n, where n is associated with an Nth memory die of the memory system. In some instances, some of the memory dies may include data dies for storing data (e.g., user data) and parity dies for storing parity information or parity bits.

The memory dies 205 may be associated with one or more codewords 210, which may represent the smallest logical construct of an associated memory system. A codeword 210 may be associated with (e.g., span) each of the memory dies 205 of the memory system and, in some instances, may be or may be associated with a single word line. For example, a first codeword 210-a may be associated with a portion of the memory die 205-a, a portion of the memory die 205-b, and a portion of the memory die 205-n. When accessing the first codeword 210-a, data may be read from or written to each of the n memory dies 205 of the memory system. In some instances, a codeword 210 may be associated with a first quantity of data (e.g., 32 B of data) and a second quantity of parity information (e.g., 8 B of parity information).

The codewords 210 may be associated with one or more MUs 215, which may also be referred to herein as an access size or a data access size. For example, a first MU 215-a may include a first codeword 210-a, a second codeword 210-b, and an nth codeword 210-n, where n is associated with an Nth codeword 210 of the first MU 215-a. A memory system may include a quantity of MUs 215 that is based on a quantity of codewords 210. In some examples, each MU 215 of the memory system may include a same or a different quantity of codewords 210 than other MUs 215. Additionally, or alternatively, the MUs 215 may be associated with one or more sectors 220. For example, a first sector 220-a may include a first MU 215-a, a second MU 215-b, and an nth MU 215-n, where n is associated with an Nth MU 215 of the first sector 220-a. A memory system may include a quantity of sectors 220 that is based on a quantity of MUs 215.

The memory system may be associated with one or more regions 225, which may represent the largest logical construct. A region 225 may be associated with (e.g., span) each of the memory dies 205 of the memory system and may be associated with one or more sectors 220. For example, a first region 225 may include a first sector 220-a, a second sector 220-b, and an nth sector 220-n, where n is associated with an Nth sector 220 of the first region 225. A memory system may include a quantity of regions 225 that is based on a quantity of sectors 220. In some examples, each region 225 of the memory system may include a same or a different quantity of sectors 220 than other regions 225. As described herein, each region 225 of a memory system may be associated with a respective error control capability (e.g., SDDC, DDDC), which may support a tradeoff between overprovisioning and reliability for regions 225 that store compressed data, which may improve the overall performance and reliability of the associated memory system.

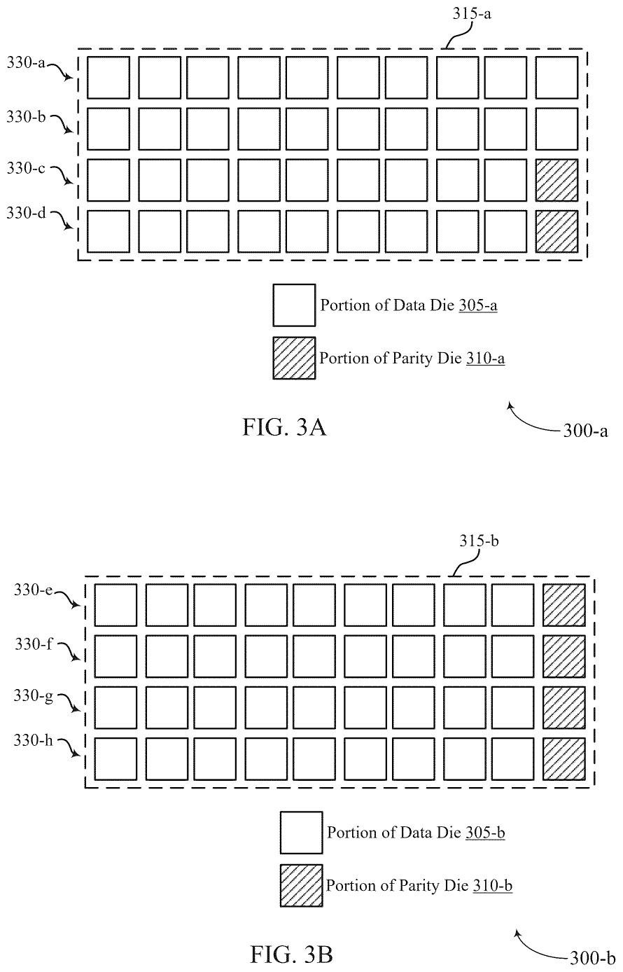

FIG. 3A illustrates an example of a memory architecture 300-a that supports dynamic error control for compressed memory in accordance with examples as disclosed herein. The memory architecture 300-a may illustrate one or more portions of data dies 205 (e.g., portions of memory dies 205 as described with reference to FIG. 2 that are for storing data) and one or more parity dies 210 (e.g., portions of memory dies 205 as described with reference to FIG. 2 that are for storing parity information or parity bits). In some instances, the memory architecture 300-a may illustrate a codeword 315-a, which may be an example of a codeword 210 as described with reference to FIG. 2. The memory architecture 300 may support a tradeoff between overprovisioning and reliability for regions (e.g., regions that include codewords 315-a) that store compressed data, which may improve the overall performance and reliability of the associated memory system.

The memory architecture 300-a illustrates respective portions of a plurality of memory dies. As described herein, the memory dies 205 as described with reference to FIG. 2 may include data dies that are for storing data (e.g., user data). For example, data dies may store data received from a host system (e.g., a host system 105 as described with reference to FIG. 1). The memory dies 205 as described with reference to FIG. 2 may also include parity dies that are for storing parity bits or parity information associated with respective data dies. For example, a parity die may store parity bits associated with respective data dies, and the parity bits may be used in error correction operations associated with the data.

Additionally, or alternatively, the data dies and the parity dies may be associated with respective ranks 330 of memory dies. As used herein, a rank may refer to a group of memory dies (e.g., memory dies 205 as described with reference to FIG. 2) that are coupled with a common chip select. Such memory dies may be accessed simultaneously (e.g., during a same duration). Accordingly, a memory system may include up to four (4) ranks, such as a first rank 330-a, a second rank 330-b, a third rank 330-c, and a fourth rank 330-d. Each of the ranks 330 may be associated with same quantity of memory dies of the memory system. For example, a memory system associated with the memory architecture 300-a may include forty (40) memory dies, and each rank 330 may be associated with ten (10) memory dies.

In some instances, the memory architecture 300-a may illustrate a codeword 315-a that is associated with respective portions of multiple data dies 305-a and respective portions of multiple parity dies 310-a. For example, the codeword 315-a may be associated with respective portions of a first quantity of data dies that may include thirty eight (38) data dies and respective portions of a second quantity of parity dies that may include two (2) parity dies. In some instances, the codeword 315-a may be associated with a single word line (or multiple word lines) of each of the memory dies of the associated memory system.

The codeword 315-a illustrated by the memory architecture 300-a may be associated with a SDDC capability. As used herein, a SDDC capability may refer to the memory system's ability (e.g., the ability of a memory system controller 140 of a memory system 110 as described with reference to FIG. 1) to correct errors associated with a single die of the memory system. When a region (e.g., a region 225 as described with reference to FIG. 2) is configured with a SDDC capability, the memory system may be able to detect and correct errors associated with a single die. In other instances, regions may be configured with a DDDC capability where the memory system may be able to detect and correct errors associated with multiple (e.g., two) memory dies. Such a dynamic error control capability may support a tradeoff between overprovisioning and reliability for regions that store compressed data, which may improve the overall performance and reliability of the associated memory system.

FIG. 3B illustrates an example of a memory architecture 300-b that supports dynamic error control for compressed memory in accordance with examples as disclosed herein. The memory architecture 300-b may illustrate a similar architecture as the architecture 300-a as described with reference to FIG. 3A, but that supports a DDDC capability. For example, the memory architecture 300-b may include up to four (4) ranks, such as a first rank 330-e, a second rank 330-f, a third rank 330-g, and a fourth rank 330-h. Each of the ranks 330 may be associated with same quantity of memory dies of the memory system. For example, a memory system associated with the memory architecture 300-b a may include forty (40) memory dies, and each rank 330 may be associated with ten (10) memory dies. As described with reference to the memory architecture 300-a of FIG. 3A, the memory architecture 300-b may similarly support a tradeoff between overprovisioning and reliability for regions (e.g., regions that include codewords 315-b) that store compressed data, which may improve the overall performance and reliability of the associated memory system.

In some instances, the memory architecture 300-b may illustrate a codeword 315-b that is associated with respective portions of multiple data dies 305-b and respective portions of multiple parity dies 310-b. For example, the codeword 315-b may be associated with respective portions of a first quantity of data dies that may include thirty six (36) data dies and respective portions of a second quantity of parity dies that may include four (4) parity dies. In some instances, the codeword 315-b may be associated with a single word line (or multiple word lines) of each of the memory dies of the associated memory system.

The codeword 315-b illustrated by the memory architecture 300-b may be associated with a DDDC capability. As used herein, a DDDC capability may refer to the memory system's ability (e.g., the ability of a memory system controller 140 of a memory system 110 as described with reference to FIG. 1) to correct errors associated with multiple (e.g., two) dies of the memory system. When a region (e.g., a region 225 as described with reference to FIG. 2) is configured with a DDDC capability, the memory system may be able to detect and correct errors associated with multiple (e.g., two) dies.

In some instances, when a region is configured with a DDDC capability, it may also be associated with a different data word size than a region configured with a SDDC capability. For example, a region configured with a SDDC capability may be associated with a data word size of 304 B, whereas a region configured with a DDDC capability may be associated with a data word size of 288 B. Despite any added complexities due to different regions having different data word sizes, enabling some regions with greater error correction capabilities (e.g., a capability to detect and correct a greater quantity of die failures) may be beneficial by improving the overall performance and reliability of the associated memory system.

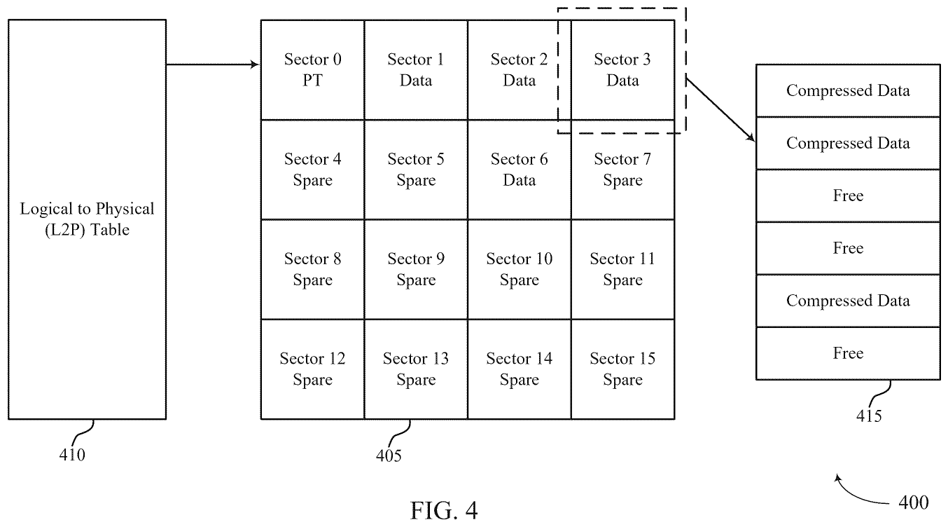

FIG. 4 shows an example of a sector diagram 400 that supports dynamic error control for compressed memory in accordance with examples as disclosed herein. In some instances, the sector diagram 400 may illustrate sectors 405, which may each be an example of a sector 220 as described with reference to FIG. 2. The sector diagram 400 may also illustrate a logical to physical (L2P) table 410 and a MU map 415. The sector diagram 400 may illustrate aspects of a memory system that supports regions having respective error control capabilities (e.g., SDDC, DDDC), which may support a tradeoff between overprovisioning and reliability for regions that store compressed data, which may improve the overall performance and reliability of the associated memory system.

In some instances, the L2P table 410 may store mappings between logical constructs (e.g., MUs, sectors 405, regions) of a memory system and the address of the physical memory cells to which the associated data is stored. In some instances, the L2P table 410 may be stored to a volatile memory of the memory system, such as SRAM. In other instances, the L2P table may be stored to a portion of one or more memory dies. However, as described herein, aspects (e.g., portions) of the L2P table 410 may be stored to one or more sectors 405.

As described with reference to FIG. 2, a sector 405 may consist of one or more MUs, and each MU may consist of one or more codewords. A sector 405 may be one of three types: a data sector, a pointer table, or a spare sector. A data sector may be used to store data, such as compressed data. As used herein, compressed data may refer to data that has been modified or otherwise altered to be smaller in size (e.g., relative to its original size). Additionally, or alternatively, each data sector may consist of MUs of a different size, but all of the MUs of a single sector may be the same size. For example, Sector 1, Sector 2, Sector 3, and Sector 6 may be configured as data sectors (e.g., for storing compressed data), and Sector 1 may include MUs of 64 B, Sector 2 may include MUs of 128 B, Sector 3 may include MUs of 192 B, and Sector 6 may include MUs of 4 KiB.

In some examples, a data sector, such as Sector 3, may store compressed data. For example, Sector 3 may be associated with MUs of 192 B. The MU map 415 may illustrate the various MUs of Sector 3. Although shown as being associated with six (6) MUs, Sector 3 may include any quantity of MUs. Additionally, or alternatively, Sector 3 may include three (3) MUs storing compressed data and 3 free (e.g., empty) MUs. In other examples, Sector 3 (and other sectors 405) may include any quantity of free and occupied MUs.

A pointer table (e.g., a pointer table sector) may store one or more portions of the L2P table 410. For example, Sector 0 may be a pointer table that stores addressing pointers that indicate (e.g., point to) the address of the physical memory cells to which the associated data is stored. A memory system may support various schemes for storing L2P information. In some instances, a pointer table may be moved due to an associated region's error control capabilities being configured (e.g., reconfigured, changed from SDDC to DDDC, etc.). In such instances, the memory system may support moving pointer tables to regions (e.g., sectors 405 of regions) having a relatively high error correction capability (e.g., DDDC) in order to ensure the associated data is relatively well protected. In other instances, the memory system may support storing pointer tables in regions (e.g., sectors 405 of regions) having a relatively low error correction capability (e.g., SDDC) and moving the pointer tables to regions (e.g., sectors 405 of regions) having the same error control capabilities.

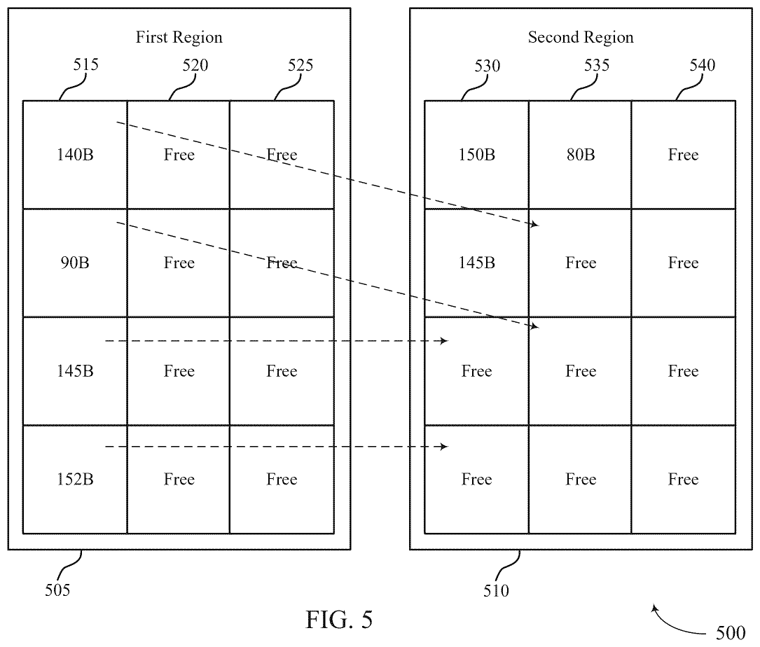

Spare sectors may be unused and may be allocated for use as a pointer table or a data sector (e.g., by a memory system controller 140 as described with reference to FIG. 1). For example, each of Sector 4, Sector 5, and Sector 7-Sector 15 may be spare sectors. In some instances, it may be desirable to move data or L2P information stored to a sector 405 of a region to a different sector 405 (e.g., a spare sector) of a different region when updating the error control capability of a region. Such aspects are further described below with reference to FIG. 5.

FIG. 5 shows an example of a region diagram 500 that supports dynamic error control for compressed memory in accordance with examples as disclosed herein. In some instances, the region diagram 500 may illustrate a first region 505 and a second region 510, which may each be an example of a region 225 as described with reference to FIG. 2. Each region may also include one or more sectors, and each sector may include one or more MUs. The region diagram 500 may illustrate aspects of a memory system that supports regions having respective error control capabilities (e.g., SDDC, DDDC), which may support a tradeoff between overprovisioning and reliability for regions that store compressed data, which may improve the overall performance and reliability of the associated memory system.

In some instances, the region diagram 500 may illustrate data being moved from the first region 505 to the second region 510 based on one or more errors (e.g., correctable errors) being detected (e.g., by the memory system controller 140 as described with reference to FIG. 1). For example, a correctable error associated with data stored to the first region 505 may be detected. The first region 505 may be operating according to a SDDC capability and the error may be associated with a single memory die. Accordingly, the error may be corrected (e.g., using SDDC) and the error control capability of the first region 505 may be updated to an error control capability that is able to correct a greater quantity of errors (e.g., a greater quantity of die failures, DDDC). In some instances, when a region operating according to DDDC experiences errors associated with two memory dies, the error control capability of the region may be further-increased (e.g., to a quad die data correction (QDDC) capability, etc.). Accordingly, the error control capabilities of a region may be continually increased when a threshold quantity of die errors is experienced for a given error control capability. Before updating the error control capability of the first region 505 or, in some instances, before correcting the error, data stored to the sectors of the first region 505 may be moved. In some instances, the data may be moved to one or more sectors of an additional region (or additional regions).

By way of example, the first region 505 may be associated with a first sector 515, a second sector 520, and a third sector 525. The first sector 515 may be associated with MUs having a size of 152 B (or less), and the second sector 520 and the third sector 525 may be spare sectors (e.g., as described with reference to FIG. 4). The second region 510 may be associated with a fourth sector 530, a fifth sector 535, and a sixth sector 540. The fourth sector 530 may be associated with MUs having a size of 152 B (or less), the fifth sector 535 may be associated with MUs having a size of 144 B (or less), and the sixth sector 540 may be a spare sector.

When a correctable error associated with the first region 505 is detected, the data stored to the first sector 515 may be moved. By way of example, the data is shown as being moved to the second region 510, however the data can be moved to any region having open sectors with MUs large enough to store the respective data. That is, the second region 510 may have a uniform error control capability, but the data can be moved to sectors of various regions having different error control capabilities.

To move the data, the memory system (e.g., a memory system controller 140 as described with reference to FIG. 4) may search for an open sector having MUs just large enough to store the respective data. For example, to move the 140 B data from the first sector 515, the memory system may search for an open sector having a MU size of 140 B or slightly larger. If selecting from a MU size of, for example, 144 B or 152 B, the memory system may select the sector having a MU size of 144 B for the 140 B data. Additionally, or alternatively, the memory system may search for open sectors for the 90 B data, the 145 B data, and the 152 B data. The 140 B data and the 90 B data may be moved to the fifth sector 535 having a MU size of 144 B and the 145 B data and the 152 B data may be moved to the fourth sector 530 having a MU size of 152 B. After moving the data, the sectors of the first region 505 may be empty (e.g., free) and the error control capability of the first region 505 may be updated (e.g., from SDDC to DDDC).

As described herein, data may be moved to sectors of regions having different error control capabilities. For example, some data may be moved to sectors of a region configured with SDDC and other data may be moved to sectors of regions configured with DDDC. The memory system may thus use an opportunistic algorithm to move (e.g., write) data to sectors that have MUs slightly large enough, that are associated with a region operating with the same error control capabilities, or both.

In some instances, moving data from a region operating according to a first error control capability to a region operating according to a second (e.g., a different) error control capability may necessitate the generation (or regeneration) of parity bits. That is, moving data from a SDDC region to a DDDC region may result in additional parity bits being generated for the data. Additionally, or alternatively, moving data from a DDDC region to a SDDC region may result in fewer parity bits being generated and filler data (e.g., dummy data) may be included when writing the data to the destination sector. Accordingly, a memory system having regions with respective error control capabilities (e.g., SDDC, DDDC) may support a tradeoff between overprovisioning and reliability for regions that store compressed data, which may improve the overall performance and reliability of the associated memory system.

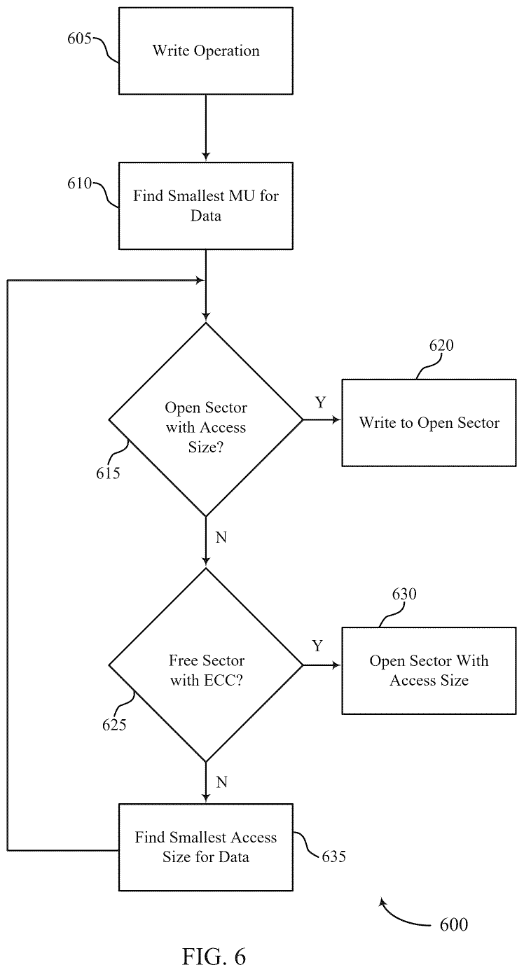

FIG. 6 shows an example of a flowchart 600 that supports dynamic error control for compressed memory in accordance with examples as disclosed herein. The flowchart 600 may illustrate aspects of writing data to a sector of a memory system. The write operations may relate to host write operations (e.g., writing data received from a host system 105 as described with reference to FIG. 1) or to moving data from one sector to another as described with reference to FIG. 4. By performing write operations as described herein, the associated memory system may support regions having respective error control capabilities (e.g., SDDC, DDDC), which may support a tradeoff between overprovisioning and reliability for regions that store compressed data, which may improve the overall performance and reliability of the associated memory system.

At 605, a write operation may be initiated. In some instances, the write operation may be initiated based on receiving a command from a host system. The command may be received, for example, by a memory system controller 140 as described with reference to FIG. 1. In other instances, the write operation may be initiated based on an error (e.g., a correctable error) being detected. For example, when the error is detected, data stored to the sector(s) of the region may be moved (e.g., written to) sectors of a different region in order to update the error control capability of the region from which the data is moved.

At 610, a smallest MU that is able to store the data may be found. In some instances, a memory system controller 140 as described with reference to FIG. 1 may determine a size of the data to be written. For example, the data may be 90 B and a sector having a MU size of 144 B may be found for writing (or otherwise moving) the data to. In some instances, there may be other available sectors having larger MU sizes but the MU having a size slightly larger than the data to be written may be desirable for storage efficiency.

At 615, it may be determined whether an open sector with the smallest MU size that is able to store the data is open. In some instances, the determination may be made by a memory system controller 140 as described with reference to FIG. 1 scanning all available sectors. Additionally, or alternatively, the error control capability of the open sectors (e.g., of the region associated with the open sectors) may be ignored. That is, the algorithm used to search for open sectors may opportunistically search for open sectors, regardless of error correction capability, having a smallest MU size that is able to store the data. If a sector with the smallest MU size that is able to store the data is open, the data may be written to the open sector at 620.

At 625, if a sector with the smallest MU size that is able to store the data is not open, it may be determined whether a free sector with the same error control capability as the data is free (e.g., whether a spare sector is available). In some instances, the determination may be made by a memory system controller 140 as described with reference to FIG. 1 scanning all available sectors. Additionally, or alternatively, the error control capability of the data may be determined based on whether the data is received (e.g., from a host system) or is being moved from a different sector. If the data is received from a host system, the data may be written to a free sector of a region operating in accordance with SDDC. If the data is being moved, the data may be written to a free sector of a region having a same error control capability as the region from which the data is being moved. If a sector with the same error control capability as the data is free, the data may be written to the free sector at 630.

At 635, if a sector with the same error control capability as the data is not free, a next smallest MU that is able to store the data may be found. In some examples, a memory system controller 140 as described with reference to FIG. 1 may search for a next smallest MU that is able to store the data. For example, if no sectors having a MU size of 152 B are available to store the data, a sector having a MU size of 152 B may be found for writing (or otherwise moving) the data to. Steps 615 through 635 of the flowchart 600 may continue until the data is written to a sector. Accordingly, the systems and methods described herein may support a tradeoff between overprovisioning and reliability for regions that store compressed data, which may improve the overall performance and reliability of the associated memory system.

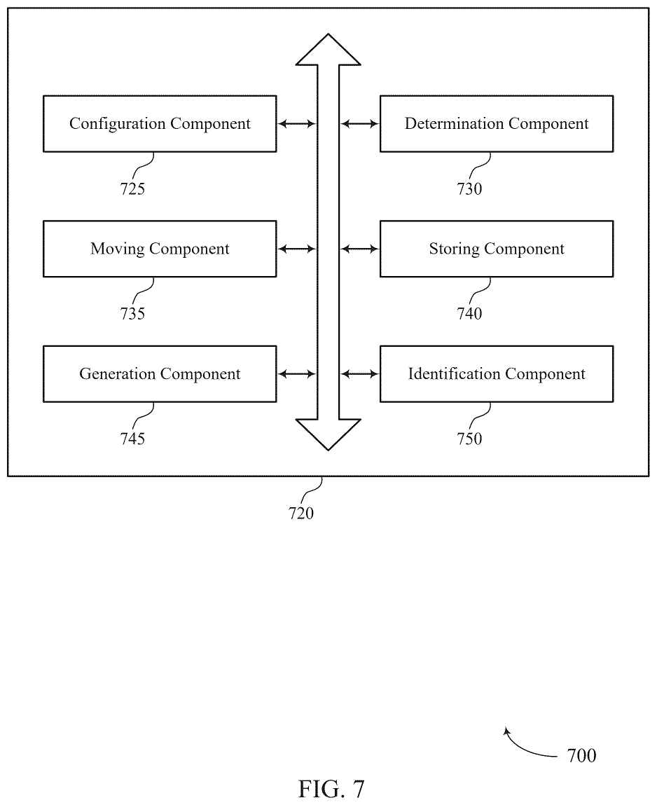

FIG. 7 shows a block diagram 700 of a memory system 720 that supports dynamic error control for compressed memory in accordance with examples as disclosed herein. The memory system 720 may be an example of aspects of a memory system as described with reference to FIGS. 1 through 6. The memory system 720, or various components thereof, may be an example of means for performing various aspects of dynamic error control for compressed memory as described herein. For example, the memory system 720 may include a configuration component 725, a determination component 730, a moving component 735, a storing component 740, a generation component 745, an identification component 750, or any combination thereof. Each of these components, or components of subcomponents thereof (e.g., one or more processors, one or more memories), may communicate, directly or indirectly, with one another (e.g., via one or more buses).

The configuration component 725 may be configured as or otherwise support a means for configuring a compressed region of the memory system to operate in accordance with a first error control capability from among a plurality of error control capabilities. The determination component 730 may be configured as or otherwise support a means for determining an occurrence of a correctable error associated with data within a first sector of the compressed region while operating the compressed region in accordance with the first error control capability. In some examples, the configuration component 725 may be configured as or otherwise support a means for configuring the compressed region to operate in accordance with a second error control capability that can correct a greater quantity of errors than the first error control capability based on determining the occurrence of the correctable error.

In some examples, the moving component 735 may be configured as or otherwise support a means for moving, in accordance with determining the occurrence of the correctable error, data previously stored to the compressed region, where moving the data is based on configuring the compressed region to operate in accordance with the second error control capability.

In some examples, to support moving the data previously stored to the compressed region, the moving component 735 may be configured as or otherwise support a means for moving at least a subset of the previously stored data and one or more corresponding parity bits to one or more other compressed regions configured to operate in accordance with the first error control capability.

In some examples, to support moving the data previously stored to the compressed region, the moving component 735 may be configured as or otherwise support a means for moving at least a subset of the previously stored data to one or more other compressed regions configured to operate in accordance with the second error control capability. In some examples, to support moving the data previously stored to the compressed region, the generation component 745 may be configured as or otherwise support a means for generating one or more new parity bits associated with at least the subset of the data based on the one or more other compressed regions being configured to operate in accordance with the second error control capability.

In some examples, the identification component 750 may be configured as or otherwise support a means for identifying, from among a plurality of sectors within one or more other compressed regions, a destination sector for data previously stored to the first sector based on a size of the data and an access size associated with the destination sector.

In some examples, the storing component 740 may be configured as or otherwise support a means for storing a plurality of mappings between logical addresses and physical addresses of the memory system to a second sector operating in accordance with the second error control capability.

In some examples, the storing component 740 may be configured as or otherwise support a means for storing a plurality of mappings between logical addresses and physical addresses of the memory system to a third sector operating in accordance with the first error control capability. In some examples, the moving component 735 may be configured as or otherwise support a means for moving the plurality of mappings to a fourth sector operating in accordance with the first error control capability based on reconfiguring the first sector to operate in accordance with the second error control capability.

In some examples, to support determining the occurrence of the correctable error associated with the compressed region, the determination component 730 may be configured as or otherwise support a means for determining an occurrence of a correctable error associated with a memory die, where the compressed region includes at least a respective portion of each of a plurality of memory dies that includes the memory die.

In some examples, the determination component 730 may be configured as or otherwise support a means for determining an occurrence of a second correctable error associated with the compressed region while operating the compressed region in accordance with the second error control capability. In some examples, the configuration component 725 may be configured as or otherwise support a means for configuring the compressed region to operate in accordance with a third error control capability that can correct a greater quantity of errors than the first error control capability and the second error control capability based on determining the occurrence of the second correctable error.

In some examples, the correctable error and the second correctable error are both associated with a same memory die.

In some examples, each sector of a plurality of sectors within the compressed region is configured to store data, is configured to store addressing information associated with the data or is designated as a spare sector.

In some examples, the compressed region includes a plurality of sectors. In some examples, each of the plurality of sectors within the compressed region are configured to operate in accordance with the second error control capability based on configuring the compressed region to operate in accordance with the second error control capability.

In some examples, the first error control capability includes an SDDC capability and the second error control capability includes a DDDC capability.

In some examples, the described functionality of the memory system 720, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 720, or various components thereof, may be implemented at least in part by instructions (e.g., stored in memory, non-transitory computer-readable medium) executable by such at least one processor.

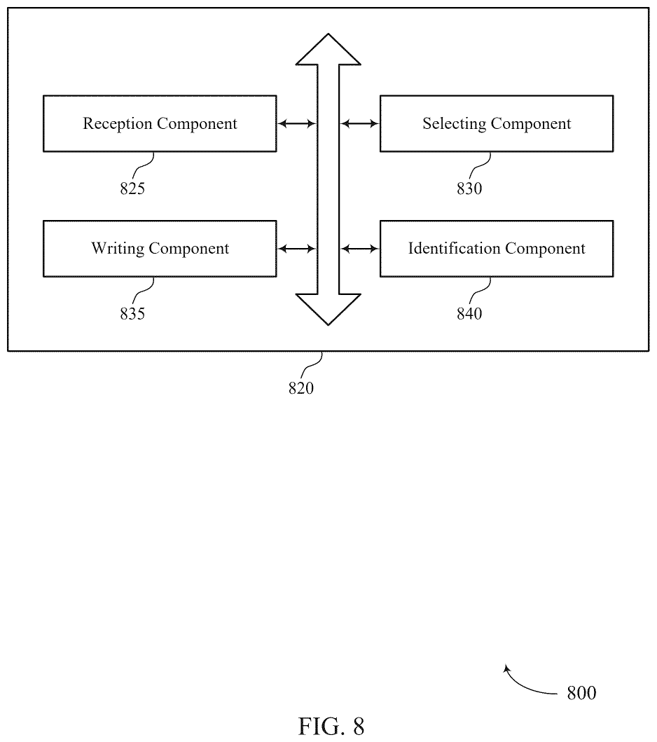

FIG. 8 shows a block diagram 800 of a memory system 820 that supports dynamic error control for compressed memory in accordance with examples as disclosed herein. The memory system 820 may be an example of aspects of a memory system as described with reference to FIGS. 1 through 6. The memory system 820, or various components thereof, may be an example of means for performing various aspects of dynamic error control for compressed memory as described herein. For example, the memory system 820 may include a reception component 825, a selecting component 830, a writing component 835, an identification component 840, or any combination thereof. Each of these components, or components of subcomponents thereof (e.g., one or more processors, one or more memories), may communicate, directly or indirectly, with one another (e.g., via one or more buses).

The reception component 825 may be configured as or otherwise support a means for receiving a write command associated with data for writing to the memory system, the memory system associated with a plurality of sectors that are each associated with a respective access size and respective error control capability. The selecting component 830 may be configured as or otherwise support a means for selecting, from among the plurality of sectors, a sector for storing the data based on an access size of the selected sector, a size of the data, an error control capability of the selected sector, or any combination thereof. The writing component 835 may be configured as or otherwise support a means for writing the data to the selected sector in accordance with the error control capability of the selected sector.

In some examples, to support selecting the sector for storing the data, the identification component 840 may be configured as or otherwise support a means for identifying, from among a plurality of respective access sizes associated with the plurality of sectors, a first access size, where the first access size is a smallest one of the plurality of respective access sizes that is larger than or equal to the size of the data, where: when the plurality of sectors includes one or more open sectors with the first access size, the selected sector has the first access size; when the plurality of sectors does not include one or more open sectors with the first access size and does include one or more free sectors with a first error control capability, the method further includes opening a sector with the first error control capability and the first access size, and the selected sector is the opened sector; and when the plurality of sectors does not include one or more open sectors with the first access size and does not include one or more free sectors with the first error control capability, the selected sector has a second access size that is larger than the first access size.

In some examples, when the plurality of sectors does not include one or more open sectors with the first access size and does include one or more free sectors with the first error control capability, selecting the sector is independent of the error control capability of the selected sector.

In some examples, the selected sector is configured to operate in accordance with a second error control capability that can correct a greater quantity of errors than the first error control capability.

In some examples, the first error control capability includes an SDDC capability and the second error control capability includes a DDDC capability.

In some examples, the described functionality of the memory system 820, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 820, or various components thereof, may be implemented at least in part by instructions (e.g., stored in memory, non-transitory computer-readable medium) executable by such at least one processor.

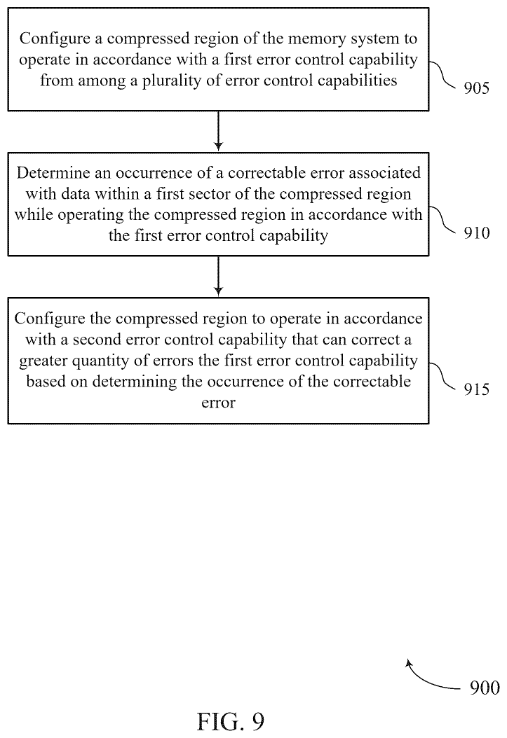

FIG. 9 shows a flowchart illustrating a method 900 that supports dynamic error control for compressed memory in accordance with examples as disclosed herein. The operations of method 900 may be implemented by a memory system or its components as described herein. For example, the operations of method 900 may be performed by a memory system as described with reference to FIGS. 1 through 7. In some examples, a memory system may execute a set of instructions to control the functional elements of the device to perform the described functions. Additionally, or alternatively, the memory system may perform aspects of the described functions using special-purpose hardware.

At 905, the method may include configuring a compressed region (e.g., first region 505, second region 510 as described with reference to FIG. 5) of the memory system to operate in accordance with a first error control capability from among a plurality of error control capabilities. In some examples, aspects of the operations of 905 may be performed by a configuration component 725 as described with reference to FIG. 7.

At 910, the method may include determining an occurrence of a correctable error associated with data within a first sector (e.g., sector 515 as described with reference to FIG. 5) of the compressed region while operating the compressed region in accordance with the first error control capability. In some examples, aspects of the operations of 910 may be performed by a determination component 730 as described with reference to FIG. 7.

At 915, the method may include configuring the compressed region to operate in accordance with a second error control capability that can correct a greater quantity of errors the first error control capability based on determining the occurrence of the correctable error. In some examples, aspects of the operations of 915 may be performed by a configuration component 725 as described with reference to FIG. 7.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for configuring a compressed region of the memory system to operate in accordance with a first error control capability from among a plurality of error control capabilities; determining an occurrence of a correctable error associated with data within a first sector of the compressed region while operating the compressed region in accordance with the first error control capability; and configuring the compressed region to operate in accordance with a second error control capability that can correct a greater quantity of errors the first error control capability based on determining the occurrence of the correctable error.

Aspect 2: The method, apparatus, or non-transitory computer-readable medium of aspect 1, further including operations, features, circuitry, logic, means, or instructions, or any combination thereof for moving, in accordance with determining the occurrence of the correctable error, data previously stored to the compressed region, where moving the data is based on configuring the compressed region to operate in accordance with the second error control capability.

Aspect 3: The method, apparatus, or non-transitory computer-readable medium of aspect 2, where moving the data previously stored to the compressed region includes operations, features, circuitry, logic, means, or instructions, or any combination thereof for moving at least a subset of the previously stored data and one or more corresponding parity bits to one or more other compressed regions configured to operate in accordance with the first error control capability.

Aspect 4: The method, apparatus, or non-transitory computer-readable medium of any of aspects 2 through 3, where moving the data previously stored to the compressed region includes operations, features, circuitry, logic, means, or instructions, or any combination thereof for moving at least a subset of the previously stored data to one or more other compressed regions configured to operate in accordance with the second error control capability and generating one or more new parity bits associated with at least the subset of the data based on the one or more other compressed regions being configured to operate in accordance with the second error control capability.

Aspect 5: The method, apparatus, or non-transitory computer-readable medium of any of aspects 2 through 4, further including operations, features, circuitry, logic, means, or instructions, or any combination thereof for identifying, from among a plurality of sectors within one or more other compressed regions, a destination sector for data previously stored to the first sector based on a size of the data and an access size associated with the destination sector.

Aspect 6: The method, apparatus, or non-transitory computer-readable medium of any of aspects 1 through 5, further including operations, features, circuitry, logic, means, or instructions, or any combination thereof for storing a plurality of mappings between logical addresses and physical addresses of the memory system to a second sector operating in accordance with the second error control capability.

Aspect 7: The method, apparatus, or non-transitory computer-readable medium of any of aspects 1 through 6, further including operations, features, circuitry, logic, means, or instructions, or any combination thereof for storing a plurality of mappings between logical addresses and physical addresses of the memory system to a third sector operating in accordance with the first error control capability and moving the plurality of mappings to a fourth sector operating in accordance with the first error control capability based on reconfiguring the first sector to operate in accordance with the second error control capability.

Aspect 8: The method, apparatus, or non-transitory computer-readable medium of any of aspects 1 through 7, where determining the occurrence of the correctable error associated with the compressed region includes operations, features, circuitry, logic, means, or instructions, or any combination thereof for determining an occurrence of a correctable error associated with a memory die, where the compressed region includes at least a respective portion of each of a plurality of memory dies that includes the memory die.

Aspect 9: The method, apparatus, or non-transitory computer-readable medium of any of aspects 1 through 8, further including operations, features, circuitry, logic, means, or instructions, or any combination thereof for determining an occurrence of a second correctable error associated with the compressed region while operating the compressed region in accordance with the second error control capability and configuring the compressed region to operate in accordance with a third error control capability that can correct a greater quantity of errors than the first error control capability and the second error control capability based on determining the occurrence of the second correctable error.

Aspect 10: The method, apparatus, or non-transitory computer-readable medium of aspect 9, where the correctable error and the second correctable error are both associated with a same memory die.

Aspect 11: The method, apparatus, or non-transitory computer-readable medium of any of aspects 1 through 10, where each sector of a plurality of sectors within the compressed region is configured to store data, is configured to store addressing information associated with the data, or is designated as a spare sector.

Aspect 12: The method, apparatus, or non-transitory computer-readable medium of any of aspects 1 through 11, where the compressed region includes a plurality of sectors and each of the plurality of sectors within the compressed region are configured to operate in accordance with the second error control capability based on configuring the compressed region to operate in accordance with the second error control capability.

Aspect 13: The method, apparatus, or non-transitory computer-readable medium of any of aspects 1 through 12, where the first error control capability includes an SDDC capability and the second error control capability includes a DDDC capability.

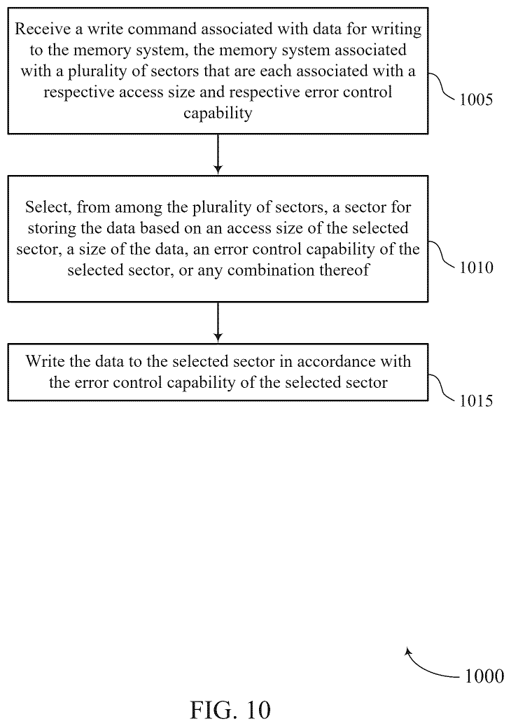

FIG. 10 shows a flowchart illustrating a method 1000 that supports dynamic error control for compressed memory in accordance with examples as disclosed herein. The operations of method 1000 may be implemented by a memory system or its components as described herein. For example, the operations of method 1000 may be performed by a memory system as described with reference to FIGS. 1 through 6 and 8. In some examples, a memory system may execute a set of instructions to control the functional elements of the device to perform the described functions. Additionally, or alternatively, the memory system may perform aspects of the described functions using special-purpose hardware.

At 1005, the method may include receiving a write command associated with data for writing to the memory system, the memory system associated with a plurality of sectors (e.g., sector 515, sector 520 as described with reference to FIG. 5) that are each associated with a respective access size and respective error control capability. In some examples, aspects of the operations of 1005 may be performed by a reception component 825 as described with reference to FIG. 8.

At 1010, the method may include selecting, from among the plurality of sectors, a sector (e.g., sector 530 as described with reference to FIG. 5) for storing the data based on an access size of the selected sector, a size of the data, an error control capability of the selected sector, or any combination thereof. In some examples, aspects of the operations of 1010 may be performed by a selecting component 830 as described with reference to FIG. 8.

At 1015, the method may include writing the data to the selected sector (e.g., sector 530 as described with reference to FIG. 5) in accordance with the error control capability of the selected sector. In some examples, aspects of the operations of 1015 may be performed by a writing component 835 as described with reference to FIG. 8.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the following aspects of the present disclosure:

Aspect 14: A method, apparatus, or non-transitory computer-readable medium including operations, features, circuitry, logic, means, or instructions, or any combination thereof for receiving a write command associated with data for writing to the memory system, the memory system associated with a plurality of sectors that are each associated with a respective access size and respective error control capability; selecting, from among the plurality of sectors, a sector for storing the data based on an access size of the selected sector, a size of the data, an error control capability of the selected sector, or any combination thereof; and writing the data to the selected sector in accordance with the error control capability of the selected sector.

Aspect 15: The method, apparatus, or non-transitory computer-readable medium of aspect 14, where selecting the sector for storing the data includes operations, features, circuitry, logic, means, or instructions, or any combination thereof for identifying, from among a plurality of respective access sizes associated with the plurality of sectors, a first access size, where the first access size is a smallest one of the plurality of respective access sizes that is larger than or equal to the size of the data, where: when the plurality of sectors includes one or more open sectors with the first access size, the selected sector has the first access size; when the plurality of sectors does not include one or more open sectors with the first access size and does include one or more free sectors with a first error control capability, the method further includes opening a sector with the first error control capability and the first access size, and the selected sector is the opened sector; and when the plurality of sectors does not include one or more open sectors with the first access size and does not include one or more free sectors with the first error control capability, the selected sector has a second access size that is larger than the first access size.

Aspect 16: The method, apparatus, or non-transitory computer-readable medium of aspect 15, where, when the plurality of sectors does not include one or more open sectors with the first access size and does include one or more free sectors with the first error control capability, selecting the sector is independent of the error control capability of the selected sector.

Aspect 17: The method, apparatus, or non-transitory computer-readable medium of aspect 16, where the selected sector is configured to operate in accordance with a second error control capability that can correct a greater quantity of errors than the first error control capability.

Aspect 18: The method, apparatus, or non-transitory computer-readable medium of aspect 17, where the first error control capability includes an SDDC capability and the second error control capability includes a DDDC capability.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
configure a compressed region of the memory system to operate in accordance with a first error control capability from among a plurality of error control capabilities;
determine an occurrence of a correctable error associated with data within a first sector of the compressed region while operating the compressed region in accordance with the first error control capability; and
configure the compressed region to operate in accordance with a second error control capability that can correct a greater quantity of errors the first error control capability based on determining the occurrence of the correctable error.

2. The memory system of claim 1, wherein the processing circuitry is further configured to cause the memory system to:
move, in accordance with determining the occurrence of the correctable error, data previously stored to the compressed region, wherein moving the data is based on configuring the compressed region to operate in accordance with the second error control capability.

3. The memory system of claim 2, wherein, to move the data previously stored to the compressed region, the processing circuitry is configured to cause the memory system to:
move at least a subset of the previously stored data and one or more corresponding parity bits to one or more other compressed regions configured to operate in accordance with the first error control capability.

4. The memory system of claim 2, wherein, to move the data previously stored to the compressed region, the processing circuitry is configured to cause the memory system to:
move at least a subset of the previously stored data to one or more other compressed regions configured to operate in accordance with the second error control capability; and
generate one or more new parity bits associated with at least the subset of the data based on the one or more other compressed regions being configured to operate in accordance with the second error control capability.

5. The memory system of claim 2, wherein the processing circuitry is further configured to cause the memory system to:
identify, from among a plurality of sectors within one or more other compressed regions, a destination sector for data previously stored to the first sector based on a size of the data and an access size associated with the destination sector.

6. The memory system of claim 1, wherein the processing circuitry is further configured to cause the memory system to:
store a plurality of mappings between logical addresses and physical addresses of the memory system to a second sector operating in accordance with the second error control capability.

7. The memory system of claim 1, wherein the processing circuitry is further configured to cause the memory system to:
store a plurality of mappings between logical addresses and physical addresses of the memory system to a third sector operating in accordance with the first error control capability; and
move the plurality of mappings to a fourth sector operating in accordance with the first error control capability based on reconfiguring the first sector to operate in accordance with the second error control capability.

8. The memory system of claim 1, wherein, to determine the occurrence of the correctable error associated with the compressed region, the processing circuitry is configured to cause the memory system to:
determine an occurrence of a correctable error associated with a memory die, wherein the compressed region includes at least a respective portion of each of a plurality of memory dies that includes the memory die.

9. The memory system of claim 1, wherein the processing circuitry is further configured to cause the memory system to:
determine an occurrence of a second correctable error associated with the compressed region while operating the compressed region in accordance with the second error control capability; and
configure the compressed region to operate in accordance with a third error control capability that can correct a greater quantity of errors than the first error control capability and the second error control capability based on determining the occurrence of the second correctable error.

10. The memory system of claim 9, wherein the correctable error and the second correctable error are both associated with a same memory die.

11. The memory system of claim 1, wherein each sector of a plurality of sectors within the compressed region is configured to store data, is configured to store addressing information associated with the data, or is designated as a spare sector.

12. The memory system of claim 1, wherein:
the compressed region comprises a plurality of sectors, and
each of the plurality of sectors within the compressed region are configured to operate in accordance with the second error control capability based on configuring the compressed region to operate in accordance with the second error control capability.

13. The memory system of claim 1, wherein the first error control capability comprises a single die data correction (SDDC) capability and the second error control capability comprises a double die data correction (DDDC) capability.

14. A memory system, comprising:
one or more memory devices; and
processing circuitry coupled with the one or more memory devices and configured to cause the memory system to:
receive a write command associated with data for writing to the memory system, the memory system associated with a plurality of sectors that are each associated with a respective access size and respective error control capability;
select, from among the plurality of sectors, a sector for storing the data based on an access size of the selected sector, a size of the data, an error control capability of the selected sector, or any combination thereof; and
write the data to the selected sector in accordance with the error control capability of the selected sector.

15. The memory system of claim 14, wherein, to select the sector for storing the data, the processing circuitry is configured to cause the memory system to:
identify, from among a plurality of respective access sizes associated with the plurality of sectors, a first access size, wherein the first access size is a smallest one of the plurality of respective access sizes that is larger than or equal to the size of the data, wherein:
when the plurality of sectors comprise one or more open sectors with the first access size, the selected sector has the first access size;
when the plurality of sectors do not comprise one or more open sectors with the first access size and does comprise one or more free sectors with a first error control capability, the processing circuitry is further configured to open a sector with the first error control capability and the first access size, and the selected sector comprises the opened sector; and
when the plurality of sectors do not comprise one or more open sectors with the first access size and does not comprise one or more free sectors with the first error control capability, the selected sector has a second access size that is larger than the first access size.

16. The memory system of claim 15, wherein, when the plurality of sectors does not comprise one or more open sectors with the first access size and does comprise one or more free sectors with the first error control capability, selecting the sector is independent of the error control capability of the selected sector.

17. The memory system of claim 16, wherein:
the selected sector is configured to operate in accordance with a second error control capability that can correct a greater quantity of errors than the first error control capability, and
the first error control capability comprises a single die data correction (SDDC) capability and the second error control capability comprises a double die data correction (DDDC) capability.

18. A method at a memory system, comprising:
configuring a compressed region of the memory system to operate in accordance with a first error control capability from among a plurality of error control capabilities;
determining an occurrence of a correctable error associated with data within a first sector of the compressed region while operating the compressed region in accordance with the first error control capability; and
configuring the compressed region to operate in accordance with a second error control capability that can correct a greater quantity of errors the first error control capability based on determining the occurrence of the correctable error.

19. The method of claim 18, further comprising:
moving, in accordance with determining the occurrence of the correctable error, data previously stored to the compressed region, wherein moving the data is based on configuring the compressed region to operate in accordance with the second error control capability.

20. The method of claim 19, wherein moving the data previously stored to the compressed region comprises:
moving at least a subset of the previously stored data and one or more corresponding parity bits to one or more other compressed regions configured to operate in accordance with the first error control capability.

21. The method of claim 19, wherein moving the data previously stored to the compressed region comprises:
moving at least a subset of the previously stored data to one or more other compressed regions configured to operate in accordance with the second error control capability; and
generating one or more new parity bits associated with at least the subset of the data based on the one or more other compressed regions being configured to operate in accordance with the second error control capability.

22. The method of claim 19, further comprising:
identifying, from among a plurality of sectors within one or more other compressed regions, a destination sector for data previously stored to the first sector based on a size of the data and an access size associated with the destination sector.

23. The method of claim 18, further comprising:
storing a plurality of mappings between logical addresses and physical addresses of the memory system to a second sector operating in accordance with the second error control capability.

24. The method of claim 18, further comprising:
storing a plurality of mappings between logical addresses and physical addresses of the memory system to a third sector operating in accordance with the first error control capability; and
moving the plurality of mappings to a fourth sector operating in accordance with the first error control capability based on reconfiguring the first sector to operate in accordance with the second error control capability.

25. The method of claim 18, wherein determining the occurrence of the correctable error associated with the compressed region comprises:
determining an occurrence of a correctable error associated with a memory die, wherein the compressed region includes at least a respective portion of each of a plurality of memory dies that includes the memory die.

26. The method of claim 18, further comprising:
determining an occurrence of a second correctable error associated with the compressed region while operating the compressed region in accordance with the second error control capability; and
configuring the compressed region to operate in accordance with a third error control capability that can correct a greater quantity of errors than the first error control capability and the second error control capability based on determining the occurrence of the second correctable error, wherein the correctable error and the second correctable error are both associated with a same memory die.

27. A method at a memory system, comprising:
receiving a write command associated with data for writing to the memory system, the memory system associated with a plurality of sectors that are each associated with a respective access size and respective error control capability;
selecting, from among the plurality of sectors, a sector for storing the data based on an access size of the selected sector, a size of the data, an error control capability of the selected sector, or any combination thereof; and
writing the data to the selected sector in accordance with the error control capability of the selected sector.

28. The method of claim 27, wherein selecting the sector for storing the data comprises:
identifying, from among a plurality of respective access sizes associated with the plurality of sectors, a first access size, wherein the first access size is a smallest one of the plurality of respective access sizes that is larger than or equal to the size of the data, wherein:
when the plurality of sectors comprises one or more open sectors with the first access size, the selected sector has the first access size;
when the plurality of sectors does not comprise one or more open sectors with the first access size and does comprise one or more free sectors with a first error control capability, the method further comprises opening a sector with the first error control capability and the first access size, and the selected sector comprises the opened sector; and
when the plurality of sectors does not comprise one or more open sectors with the first access size and does not comprise one or more free sectors with the first error control capability, the selected sector has a second access size that is larger than the first access size.

29. The method of claim 28, wherein, when the plurality of sectors does not comprise one or more open sectors with the first access size and does comprise one or more free sectors with the first error control capability, selecting the sector is independent of the error control capability of the selected sector.

30. A non-transitory computer-readable medium storing code, the code comprising instructions executable by one or more processors to:
configure a compressed region of a memory system to operate in accordance with a first error control capability from among a plurality of error control capabilities;
determine an occurrence of a correctable error associated with data within a first sector of the compressed region while operating the compressed region in accordance with the first error control capability; and
configure the compressed region to operate in accordance with a second error control capability that can correct a greater quantity of errors the first error control capability based on determining the occurrence of the correctable error.
